(19) United States
(12) Patent Application Publication
(10) Pub. No.: US 2019/0181430 A1
(43) Pub. Date: Jun. 13, 2019

(54) LITHIUM-ION BATTERY, AND THE METHOD FOR PRODUCING THE SAME

(71) Applicant: ROBERT BOSCH GMBH, Stuttgart (DE)

(72) Inventors: Yuqian DOU, Shanghai (CN); Jingjun ZHANG, Shanghai (CN); Rongrong JIANG, Shanghai (CN); Lei WANG, Shanghai (CN); Xiaogang HAO, Shanghai (CN); Qiang LU, Shanghai (CN)

(73) Assignee: Robert Bosch GmbH, Stuttgart (DE)

(21) Appl. No.: 16/310,510

(22) PCT Filed: Jun. 15, 2016
(86) PCT No.: PCT/CN2016/085877

§ 371 Date: Dec. 17, 2018

(51) Int. Cl. H01M 4/1393; H01M 10/0525; H01M 4/133; H01M 10/44; H01M 4/134

(52) U.S. Cl. CPC H01M 4/1393; H01M 10/0525; H01M 4/134; H01M 10/446; H01M 4/133

(57) ABSTRACT

The present invention relates to a lithium-ion battery, a method for producing a lithium-ion battery, and a formation process for a lithium-ion battery.

### TECHNICAL FIELD

The present invention relates to a lithium-ion battery, a method for producing a lithium-ion battery, and a formation process for a lithium-ion battery.

### BACKGROUND ART

There are growing demands for the next-generation lithium ion batteries with a high energy density as well as a long cycle life for largescale applications, such as electric vehicles. The Li-ion batteries with high-energy-density anode materials, such as silicon- or tin-based anode materials, have attracted significant attention. One limitation when using these materials is the high irreversible capacity loss, which results in a low Coulombic efficiency in initial cycles; another challenge for using these materials is the poor cycling performance caused by the volume change during charge/discharge.

In the effort to design a high-power battery, the reduction of active material particle size to nano-scale can help shorten the diffusion length of charge carriers, enhance the Li-ion diffusion coefficient, and therefore achieve faster reaction kinetics. However, nano-sized active materials have a large surface area, which results in a high irreversible capacity loss due to the formation of a solid electrode interface (SEI). For silicon oxide based anode, the irreversible reaction during the first lithiation also leads to a large irreversible capacity loss in initial cycle. This irreversible capacity loss consumes Li in the cathode, which decreases the capacity of the full cell.

Even worse, for Si-based anode, repeated volume change during cycling reveals more and more fresh surface on the anode, which leads to continuous growth of SEI. And the continuous growth of SEI continuously consumes Li in the cathode, which results in capacity decay for the full cell.

Parallel to the effort of stabilizing the SEI with electrolyte, it is also possible to solve the problem by creating a lithium reservoir with prelithiation in the anode. Current prelithiation methods often involve a treatment of coated anode tape. This could be an electrochemical process, or physical contact of the anode with stabilized lithium metal powder.

However, these prelithiation procedure requires additional steps to the current battery production method. Furthermore, due to the highly active nature of the prelithiated anode, the subsequent battery production procedure requires an environment with well-controlled humidity, which results in an increased cost for the cell production.

### SUMMARY OF INVENTION

The present invention provides an alternative method of in-situ prelithiation. The lithium source for prelithaition comes from the cathode. During the first formation cycle, by increasing the cut-off voltage of the full cell, additional amount of lithium is extracted from the cathode; by controlling the discharge capacity, the additional lithium extracted from the cathode is stored at the anode, and this is ensured in the following cycles by maintaining the upper cut-off voltage the same as in the first cycle.

The present invention, according to one aspect, relates to a formation process for a lithium-ion battery comprising a cathode, an anode, and an electrolyte, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

The present invention, according to another aspect, relates to a lithium-ion battery comprising a cathode, an anode, and an electrolyte, characterized in that said lithium-ion battery is subjected to the formation process according to the present invention.

The present invention, according to another aspect, relates to a method for producing a lithium-ion battery comprising a cathode, an anode, and an electrolyte, wherein said method includes the following steps:
1) assembling the anode and the cathode to obtain said lithium-ion battery, and
2) subjecting said lithium-ion battery to the formation process according to the present invention.

### BRIEF DESCRIPTION OF DRAWINGS

Each aspect of the present invention will be illustrated in more detail in conjunction with the accompanying drawings, wherein :

FIG. 1 shows the discharge/charge curve of the cell of Comparative Example P2-CE1, wherein “1”, “4”, “50” and “100” stand for the 1^{st}, 4^{th}, 50^{th} and 100^{th} cycle respectively;

FIG. 2 shows the discharge/charge curve of the cell of Example P2-E1, wherein “1”, “4”, “50” and “100” stand for the 1^{st}, 4^{th}, 50^{th} and 100^{th} cycle respectively;

FIG. 3 shows the cycling performances of the cells of a) Comparative Example P2-CE1 (dashed line) and b) Example P2-E1 (solid line);

FIG. 4 shows the average charge voltage a) and the average discharge voltage b) of the cell of Comparative Example P2-CE1;

FIG. 5 shows the average charge voltage a) and the average discharge voltage b) of the cell of Example P2-E1.

### DETAILED DESCRIPTION OF PREFERRED EMBODIMENTS

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

The present invention, according to one aspect, relates to a formation process for a lithium-ion battery comprising a cathode, an anode, and an electrolyte, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

In the context of the present invention, the term “formation process” means the initial one or more charging/discharging cycles of the lithium-ion battery for example at 0.1C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV.

In accordance with another embodiment of the formation process according to the present invention, the nominal charge cut off voltage of the battery can be about 4.2 V±50 mV, and the nominal discharge cut off voltage of the battery can be about 2.5 V±50 mV.

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

For the traditional lithium-ion batteries, when the battery is charged to a cut off voltage greater than the nominal charge cut off voltage, metallic lithium will be plated on the anode, the cathode material becomes an oxidizing agent, produces carbon dioxide (CO₂), and increases the battery pressure.

In case of a preferred lithium-ion battery defined below according to the present invention, when the battery is charged to a cut off voltage greater than the nominal charge cut off voltage, additional Li⁺ ions can be intercalated into the anode having additional capacity, instead of being plated on the anode.

In case of another preferred lithium-ion battery defined below according to the present invention, in which the electrolyte comprises one or more fluorinated carbonate compounds as a nonaqueous organic solvent, the electrochemical window of the electrolyte can be broadened, and the safety of the battery can still be ensured at a charge cut off voltage of 5V or even higher.

The present invention, according to another aspect, relates to a lithium-ion battery comprising a cathode, an anode, and an electrolyte, characterized in that said lithium-ion battery is subjected to the formation process according to the present invention.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the lithium-ion battery according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r−0.75V_{off}−3.134 (V).

In accordance with another embodiment of the lithium-ion battery according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}²+7.6643V_{off}−18.33 (Va).

In accordance with another embodiment of the lithium-ion battery according to the present invention, the nominal initial surface capacity a of the cathode and the initial surface capacity b of the anode satisfy the relation formulae

1<b·η₂/(a·(1+r)−b·(1−η₂))−∈≤1.2 (I′),

preferably 1.05≤b·η₂/(a·(1+r)−b·(1−η₂))−∈≤1.15 (Ia′),

more preferably 1.08≤b·η₂/(a·(1+r)−b·(1−η₂))−∈≤1.12 (Ib′),

0<∈≤((a·η₁)/0.6−(a−b·(1−η₂)))/b (II),

where

∈ is the prelithiation degree of the anode, and

η₂ is the initial coulombic efficiency of the anode.

According to the present invention, the term “prelithiation degree” ∈ of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the lithium-ion battery according to the present invention, the prelithiation degree of the anode can be defined as

∈=((a·n₁)/c−(a−b·(1−η₂))/b (III),

0.6≤c<1 (IV),

preferably 0.7≤c<1 (IVa),

more preferably 0.7≤c≤0.9 (IVb),

particular preferably 0.75≤c≤0.85 (IVc),

where

η₁ is the initial coulombic efficiency of the cathode, and

c is the depth of discharge (DoD) of the anode.

In particular, ∈=(b·(1−η₂)−a·(1−η₁))/b, when c=1.

In accordance with another embodiment of the lithium-ion battery according to the present invention, the electrolyte comprises one or more fluorinated carbonate compounds, preferably fluorinated cyclic or acyclic carbonate compounds, as a nonaqueous organic solvent.

In accordance with another embodiment of the lithium-ion battery according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the lithium-ion battery according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the lithium-ion battery according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

In accordance with another embodiment of the lithium-ion battery according to the present invention, after being subjected to the formation process, said lithium-ion battery can still be charged to a cut off voltage V_{off}, which is greater than the nominal charge cut off voltage of the battery, and be discharged to the nominal discharge cut off voltage of the battery.

In accordance with another embodiment of the lithium-ion battery according to the present invention, after being subjected to the formation process, said lithium-ion battery can still be charged to a cut off voltage V_{off}, which is up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and be discharged to the nominal discharge cut off voltage of the battery.

The present invention, according to another aspect, relates to a method for producing a lithium-ion battery comprising a cathode, an anode, and an electrolyte, wherein said method includes the following steps:

1) assembling the anode and the cathode to obtain said lithium-ion battery, and

2) subjecting said lithium-ion battery to the formation process according to the present invention.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the method according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=0.75V_{off}−3.134 (V).

In accordance with another embodiment of the method according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=0.7857V_{off}²+7.6643V_{off}−18.33 (Va).

In accordance with another embodiment of the method according to the present invention, the nominal initial surface capacity a of the cathode and the initial surface capacity b of the anode satisfy the relation formulae

1<b·η₂/(a·(1+r)−b·(1−η₂))−∈≤1.2 (I′),

preferably 1.05≤b·η₂/(a·(1+r)−b·(1−η₂))−∈≤1.15 (Ia′),

more preferably 1.08≤b·η₂/(a·(1+r)−b·(1−η₂))−∈≤1.12 (Ib′),

0<∈≤((a·η₁)/0.6−(a−b·(1−η₂)))/b (II),

where

∈ is the prelithiation degree of the anode, and

η₂ is the initial coulombic efficiency of the anode.

According to the present invention, the term “prelithiation degree” ∈ of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the method according to the present invention, the prelithiation degree of the anode can be defined as

∈=((a·η₁)/c−(a−b·(1−η₂)))/b (III),

0.6≤c<1 (IV),

preferably 0.7≤c≤1 (IVa),

more preferably 0.7≤c≤0.9 (IVb),

particular preferably 0.75≤c≤0.85 (IVc),

where

η₁ is the initial coulombic efficiency of the cathode, and

c is the depth of discharge (DoD) of the anode.

In particular, ∈=(b·(1−η₂)−a·(1−η₁))/b, when c=1.

In accordance with another embodiment of the method according to the present invention, the electrolyte comprises one or more fluorinated carbonate compounds, preferably fluorinated cyclic or acyclic carbonate compounds, as a nonaqueous organic solvent.

In accordance with another embodiment of the method according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the method according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the method according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

Examples P2 for Prelithiation

Size of the pouch cell: 46 mm×68 mm (cathode); 48 mm×71 mm (anode);
Cathode: 96.5 wt. % of NCM-111 from BASF, 2 wt. % of PVDF Solef 5130 from Sovey, 1 wt. % of Super P Carbon Black C65 from Timcal, 0.5 wt. % of conductive graphite KS6L from Timcal;
Anode: 40 wt. % of Silicon from Alfa Aesar, 40 wt. % of graphite from BTR, 10 wt. % of NaPAA, 8 wt. % of conductive graphite KS6L from Timcal, 2 wt. % of Super P Carbon Black C65 from Timcal;
Electrolyte: 1M LiPF₆/EC+DMC (1:1 by volume, ethylene carbonate (EC), dimethyl carbonate (DMC), including 30 vol.% of fluoroethylene carbonate (FEC), based on the total nonaqueous organic solvent);

Separator: PP/PE/PP membrane Celgard 2325.

Comparative Example P2-CE1:

A pouch cell was assembled with a cathode initial capacity of 3.83 mAh/cm² and an anode initial capacity of 4.36 mAh/cm² in an Argon-filled glove box (MB-10 compact, MBraun). The cycling performance was evaluated at 25° C. on an Arbin battery test system at 0.1C for formation and at 1C for cycling, wherein the cell was charged to the nominal charge cut off voltage 4.2 V, and discharged to the nominal discharge cut off voltage 2.5 V or to a cut off capacity of 3.1 mAh/cm². The calculated prelithiation degree c of the anode was 0.

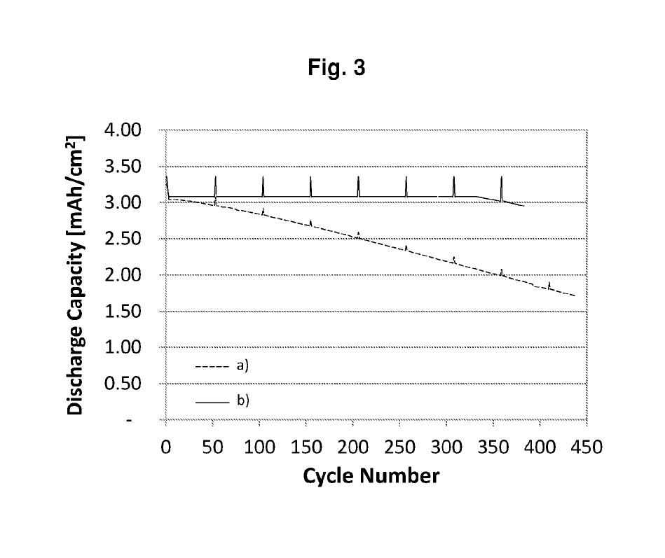

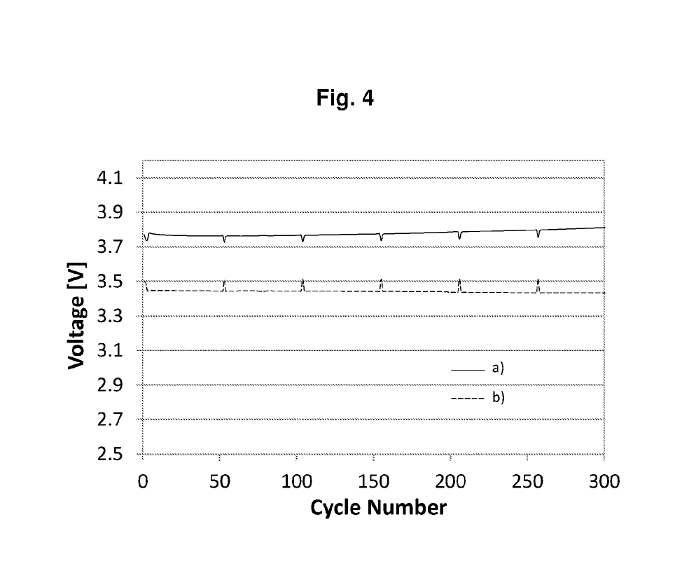

FIG. 1 shows the discharge/charge curve of the cell of Comparative Example P2-CE1, wherein “1”, “4”, “50” and “100” stand for the 1^{st}, 4^{th}, 50^{th} and 100^{th} cycle respectively. FIG. 3 shows the cycling performances of the cells of a) Comparative Example P2-CE1 (dashed line). FIG. 4 shows the average charge voltage a) and the average discharge voltage b) of the cell of Comparative Example P2-CE1.

Example P2-E1:

A pouch cell was assembled with a cathode initial capacity of 3.73 mAh/cm² and an anode initial capacity of 5.17 mAh/cm² in an Argon-filled glove box (MB-10 compact, MBraun). The cycling performance was evaluated at 25° C. on an Arbin battery test system at 0.1C for formation and at 1C for cycling, wherein the cell was charged to a cut off voltage of 4.5 V, which was 0.3 V greater than the nominal charge cut off voltage, and discharged to the nominal discharge cut off voltage 2.5 V or to a cut off capacity of 3.1 mAh/cm². The calculated prelithiation degrees ∈ of the anode was 21%.

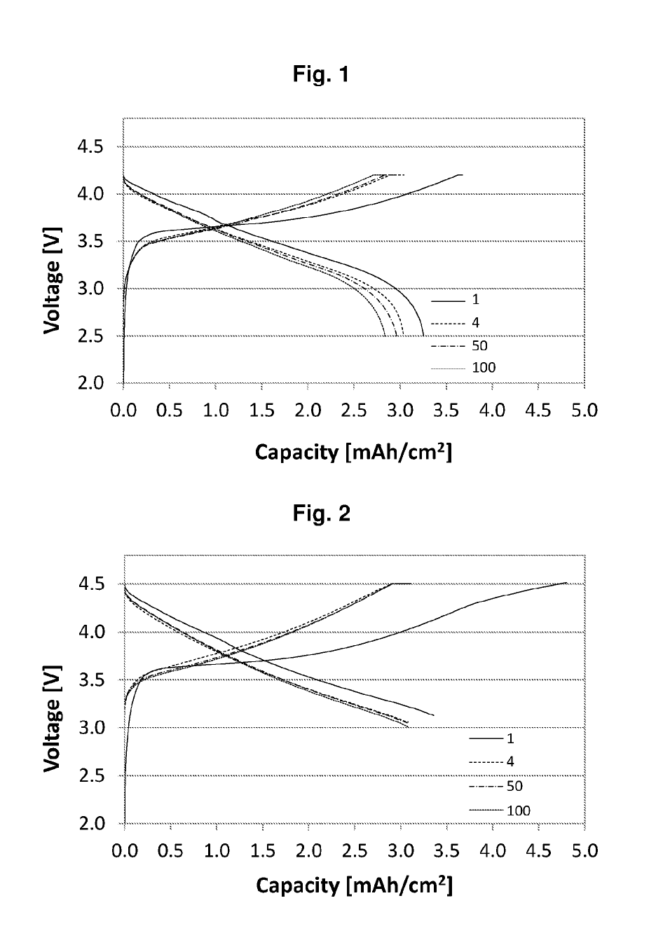

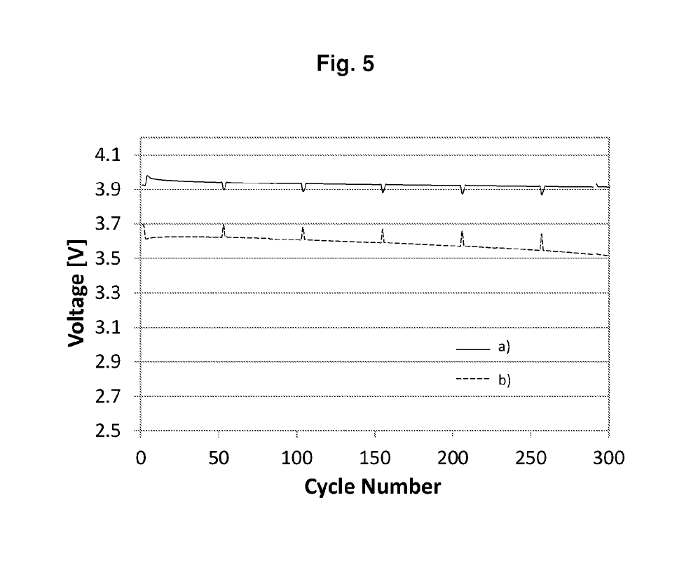

FIG. 2 shows the discharge/charge curve of the cell of Example P2-E1, wherein “1”, “4”, “50” and “100” stand for the 1^{st}, 4^{th}, 50^{th} and 100^{th} cycle respectively. FIG. 3 shows the cycling performances of the cells of b) Example P2-E1 (solid line). FIG. 5 shows the average charge voltage a) and the average discharge voltage b) of the cell of Example P2-E1.

While certain embodiments have been described, these embodiments have been presented by way of example only, and are not intended to limit the scope of the inventions. The attached claims and their equivalents are intended to cover all the modifications, substitutions and changes as would fall within the scope and spirit of the invention.

1. A formation process for a lithium-ion battery comprising a cathode, an anode, and an electrolyte, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

2. The formation process of claim 1, characterized in that the nominal charge cut off voltage of the battery is about 4.2 V, and the nominal discharge cut off voltage of the battery is about 2.5 V.

3. The formation process of claim 1, characterized in that the Coulombic efficiency of the cathode in the initial formation cycle is 40%˜80%, preferably 50%˜70%.

4. The formation process of claim 1, characterized in that said formation process further includes one or two or more formation cycles, which are carried out in the same way as the initial formation cycle.

5. A lithium-ion battery comprising a cathode, an anode, and an electrolyte, characterized in that said lithium-ion battery is subjected to the formation process of claim 1.

6. The lithium-ion battery of claim 5, characterized in that the relative increment r of the initial surface capacity of the cathode over the nominal initial surface capacity a of the cathode and the cut off voltage V_{off} satisfy the following linear equation with a tolerance of ±10%
r=0.75V_{off}−3.134 (V).

7. The lithium-ion battery of claim 5, characterized in that the relative increment r of the initial surface capacity of the cathode over the nominal initial surface capacity a of the cathode and the cut off voltage V_{off} satisfy the following quadratic equation with a tolerance of ±10%
r=−0.7857V_{off}²+7.6643V_{off}−18.33 (Va).

8. The lithium-ion battery of claim 5, characterized in that the nominal initial surface capacity a of the cathode and the initial surface capacity b of the anode satisfy the relation formulae
1<b·η₂/(a·(1+r)−b·(1−η₂))−∈≤1.2 (I′),
preferably 1.05≤b·η₂/(a·(1+r)−b·(1−η₂))−∈≤1.15 (Ia′),
more preferably 1.08≤b·η₂/(a·(1+r)−b·(1−η₂))−∈≤1.12 (Ib′),
0<∈≤((a·η₁)/0.6−(a−b·(1−η₂)))/b (II),
where
∈ is the prelithiation degree of the anode, and
η₂ is the initial coulombic efficiency of the anode.

9. The lithium-ion battery of claim 5, characterized in that
∈=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
η₁ is the initial coulombic efficiency of the cathode, and
c is the depth of discharge of the anode.

10. The lithium-ion battery of claim 5, characterized in that the electrolyte comprises one or more fluorinated carbonate compounds, preferably fluorinated cyclic or acyclic carbonate compounds, as a nonaqueous organic solvent.

11. The lithium-ion battery of claim 10, characterized in that the fluorinated carbonate compounds are selected from the group consisting of monofluorinated, difluorinated, trifluorinated, tetrafluorinated, perfluorinated ethylene carbonate, propylene carbonate, dimethyl carbonate, methyl ethyl carbonate, and diethyl carbonate.

12. The lithium-ion battery of claim 10, characterized in that the content of the fluorinated carbonate compounds is 10˜100 vol. %, based on the total nonaqueous organic solvent.

13. The lithium-ion battery of claim 5, characterized in that the active material of the anode is selected from the group consisting of carbon, silicon, silicon intermetallic compound, silicon oxide, silicon alloy and mixtures thereof.

14. The lithium-ion battery of claim 5, characterized in that the active material of the cathode is selected from the group consisting of lithium nickel oxide, lithium cobalt oxide, lithium manganese oxide, lithium nickel cobalt oxide, lithium nickel cobalt manganese oxide, and mixtures thereof.

15. The lithium-ion battery of claim 5, characterized in that after being subjected to the formation process, said lithium-ion battery is still charged to a cut off voltage V_{off}, which is greater than the nominal charge cut off voltage of the battery, preferably up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and is discharged to the nominal discharge cut off voltage of the battery.

16. A method for producing a lithium-ion battery comprising a cathode, an anode, and an electrolyte, wherein said method includes the following steps:
1) assembling the anode and the cathode to obtain said lithium-ion battery, and
2) subjecting said lithium-ion battery to the formation process of claim 1.

17. The method of claim 16, characterized in that the relative increment r of the initial surface capacity of the cathode over the nominal initial surface capacity a of the cathode and the cut off voltage V_{off} satisfy the following linear equation with a tolerance of ±10%
r=0.75V_{off}−3.134 (V).

18. The method of claim 16, characterized in that the relative increment r of the initial surface capacity of the cathode over the nominal initial surface capacity a of the cathode and the cut off voltage V_{off} satisfy the following quadratic equation with a tolerance of ±10%
r=−0.7857V_{off}²+7.6643V_{off}−18.33 (Va).

19. The method of claim 16, characterized in that the nominal initial surface capacity a of the cathode and the initial surface capacity b of the anode satisfy the relation formulae
1<b·η₂/(a·(1+r)−b·(1−η₂))−∈≤1.2 (I′),
preferably 1.05≤b·η₂/(a·(1+r)−b·(1−η₂))−∈≤1.15 (Ia′),
more preferably 1.08≤b·η₂/(a·(1+r)−b·(1−η₂))−∈≤1.12 (Ib′),
0<∈≤((a·η₁)/0.6−(a−b·(1−η₂)))/b (II),
where
∈ is the prelithiation degree of the anode, and
η₂ is the initial coulombic efficiency of the anode.

20. The method of claim 16, characterized in that
∈=((a·η₁)/c−(a−b·(1−η₂))/b (III),
0.6≤c<1 (IV),
preferably 0.7≤c<1 (IVa),
more preferably 0.7≤c≤0.9 (IVb),
particular preferably 0.75≤c≤0.85 (IVc),
where
η₁ is the initial coulombic efficiency of the cathode, and
c is the depth of discharge of the anode.

21. The method of claim 16, characterized in that the electrolyte comprises one or more fluorinated carbonate compounds, preferably fluorinated cyclic or acyclic carbonate compounds, as a nonaqueous organic solvent.

22. The method of claim 21, characterized in that the fluorinated carbonate compounds are selected from the group consisting of monofluorinated, difluorinated, trifluorinated, tetrafluorinated, perfluorinated ethylene carbonate, propylene carbonate, dimethyl carbonate, methyl ethyl carbonate, and diethyl carbonate.

23. The method of claim 21, characterized in that the content of the fluorinated carbonate compounds is 10˜100 vol. %, based on the total nonaqueous organic solvent.

24. The method of claim 16, characterized in that the active material of the anode is selected from the group consisting of carbon, silicon, silicon intermetallic compound, silicon oxide, silicon alloy and mixtures thereof.

25. The method of claim 16, characterized in that the active material of the cathode is selected from the group consisting of lithium nickel oxide, lithium cobalt oxide, lithium manganese oxide, lithium nickel cobalt oxide, lithium nickel cobalt manganese oxide, and mixtures thereof.

26. The formation process of claim 1, characterized in that the cut off voltage V_{off} is about 0.3 V greater than the nominal charge cut off voltage of the battery.
